(19) United States
(12) Patent Application Publication
(10) Pub. No.: US 2015/0287144 A1
(43) Pub. Date: Oct. 8, 2015

(54) METHOD AND SYSTEM FOR MATCHING CLOSED ACCOUNT RECORDS TO ACTIVE ACCOUNTS FOR HISTORICAL DATA PURPOSES

(71) Applicant: Pitney Bowes Inc., Stamford, CT (US)

(72) Inventor: VADIM L STELMAN, Trumbull, CT (US)

(73) Assignee: Pitney Bowes Inc., Stamford, CT (US)

(21) Appl. No.: 14/245,120

(22) Filed: Apr. 4, 2014

(51) Int. Cl. G06Q 40/00

(52) U.S. Cl. CPC G06Q 40/12

(57) ABSTRACT

A system and method that can match closed account records to active account records for use in analyzing multi-account customer locations across several time periods is provided. The output contains the best possible groupings of the active and inactive customer accounts. The process begins with the most recent view of the customer and goes back in the history of the match results generated using the known four part process. The process generates new groupings of the active and inactive entities of the same customer locations using different rules for historical groups to determine in which new groupings each old group should be placed. The new groupings group together not only the current accounts of a business location but also the accounts that used to belong to that location earlier during the period being analyzed to allow for a complete analysis of the customer location.

### FIELD OF THE INVENTION

The invention disclosed herein relates generally to systems and methods for data analysis, and more particularly to systems and methods that can match closed account records to active account records for use in analyzing multi-account customer locations across several time periods.

### BACKGROUND OF THE INVENTION

There are numerous instances when business-to-business (B2B) companies or other entities need to clean and enrich its list of business customers. This is often achieved by a known four part matching process that is periodically performed, which results in the output of an address matching result output file. In the first part, records within each client list and between different client lists maintained by the business are cross-matched by name, address, etc. to identify duplicates (also known as de-duping). In the second part, a license to use records from a third party business list vendor, such as, for example, Dun & Bradstreet, Experian, etc., is obtained. In the third part, the licensed records are used to enrich the clients lists with information including, for example, credit score, business hierarchy (branch/subsidiary links), contact names, etc. The fourth part includes identifying the matched customer accounts in a way that all of the accounts of the same customer locations and all of the corresponding third party licensed records (if any) are grouped together and identified by a single group identifier. These address matching records allow analysts to, for example, identify the total revenue from a customer location by summarizing the revenue of all the accounts at that location, which is useful for customer segmentation, building an enterprise view of a customer, etc. Difficulties in doing this arise, however, when there is a need of computing trends that require a retrospective look at a multi-account customer location across several time periods. In such a situation, the company analysts need to group together not only the current accounts of a business location but also the accounts that used to belong to that location earlier during the period being analyzed in case those accounts had some revenue during the period included in the trend.

These difficulties are caused by several major factors as follows: (i) Most companies don't keep information, e.g., name, address, etc., of closed accounts up-to-date. Many times because of this, closed accounts are simply excluded from subsequent matching periods, but even if they are included, their matching information will eventually become unreliable. (ii) Two or more different locations of the same growing customer could have been one single location in the past, i.e., the location “split.” (iii) Equipment or service covered by an account may move between two existing customer locations and that makes it difficult to keep the link between any new accounts at the new locations and the accounts cancelled while still at the old location (“equipment relocation”). Too often the company discovers these difficulties when the matching is well under way, making it difficult to go back to past periods and change the process to accommodate different logic. These causes lead to mistakes when grouping together the closed and active accounts at the same customer location. The number of these mistakes increases for larger and rapidly growing customers because these customers are more likely to have multiple accounts, and/or match to multiple third party licensed records.

### SUMMARY OF THE INVENTION

The present invention provides a system and method that can match closed accounts to active accounts for use in analyzing multi-account customer locations across several time periods. The output contains the best possible groupings of the active and inactive customer accounts. The process begins with the most recent view of the customer and goes back in the history of the match results generated using the known four part process. The process generates new groupings of the active and inactive entities of the same customer locations using different rules for historical groups to determine in which new groupings each old group should be placed. The new groupings group together not only the current accounts of a business location but also the accounts that used to belong to that location earlier during the period being analyzed to allow for a complete analysis of customer location.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, by way of example serve to explain the invention in more detail. As shown throughout the drawings, like reference numerals designate like or corresponding parts.

FIG. 1 illustrates in block diagram form a processing system that can be used to perform matching according to an embodiment of the present invention;

FIG. 2 illustrates in flow diagram form a post-matching process according to an embodiment of the present invention;

FIG. 3 illustrates in flow diagram form a portion of the post-matching process according to an embodiment of the present invention;

FIG. 4 illustrates an example of matched address grouping records that can be used to perform a matching process according to an embodiment of the present invention;

FIGS. 5A-5D illustrate examples of a new file matching record as generated according to an embodiment of the present invention;

FIGS. 6-7 illustrate examples of address matching records used during processing of the new file matching record illustrated in FIGS. 5A-5D.

### DETAILED DESCRIPTION OF THE PRESENT INVENTION

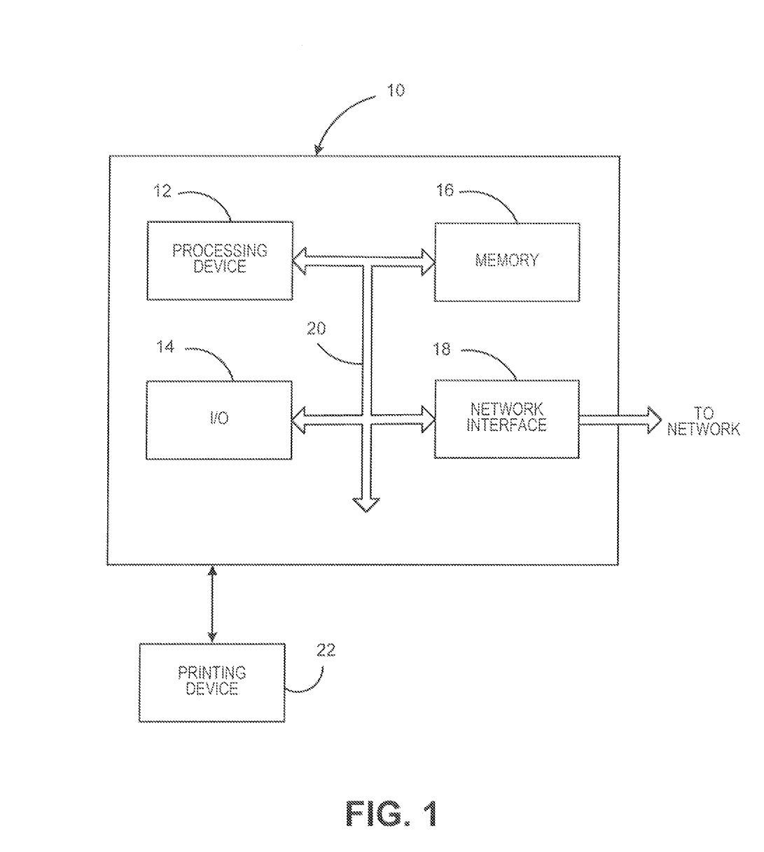

In describing the present invention, reference is made to the drawings, wherein there is seen in FIG. 1 in block diagram form a portion of a processing system 10 that can be used to perform a matching process according to an embodiment of the present invention. Processing system 10 may be a personal computer, server, mainframe or the like that includes at least one processing device 12. Processing system 10 may be specially constructed for the required purposes, or it may comprise a general purpose computer selectively activated or reconfigured by a computer program (described further below) stored therein. Such a computer program may alternatively be stored in a computer readable storage medium, such as, but not limited to, any type of disk including floppy disks, optical disks, CD-ROMs, and magnetic optical disks, read-only memories (ROMs), random access memories (RAMS), EPROMs, EEPROMs, magnetic or optical cards, or any type of media suitable for storing electronic instructions, which are executable by the processing device 12. System 10 can include one or more input/output devices 14, which can include, for example, a display, keyboard, disc drive, etc. The processing device 12 utilizes a memory device 16 for storing data and operating instructions. Memory device 16 can include one or more of the different types of memory described above. A network interface 18 is provided to allow the system 10 to communicate with other processing systems via a network, such as, for example, the Internet or a LAN. Each of the components of the system 10 communicate via a system bus 20. A printing device 22, such as a laser printer or ink jet printer, can be coupled to the system 10. One of ordinary skill in the art would be familiar with the general components of a processing system upon which the method of the present invention may be performed. In addition, the method may be performed using more than one such processing system.

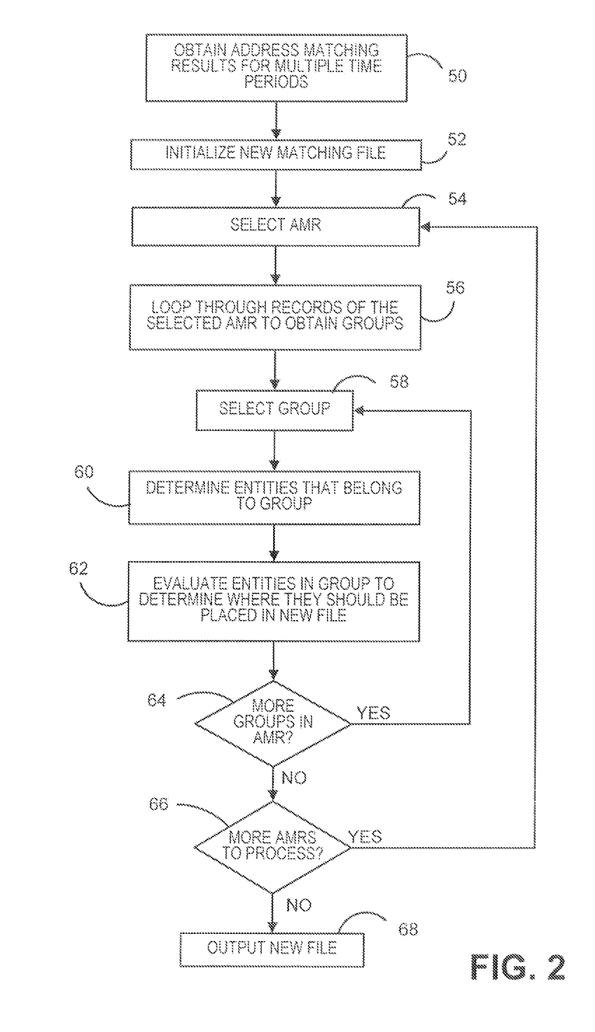

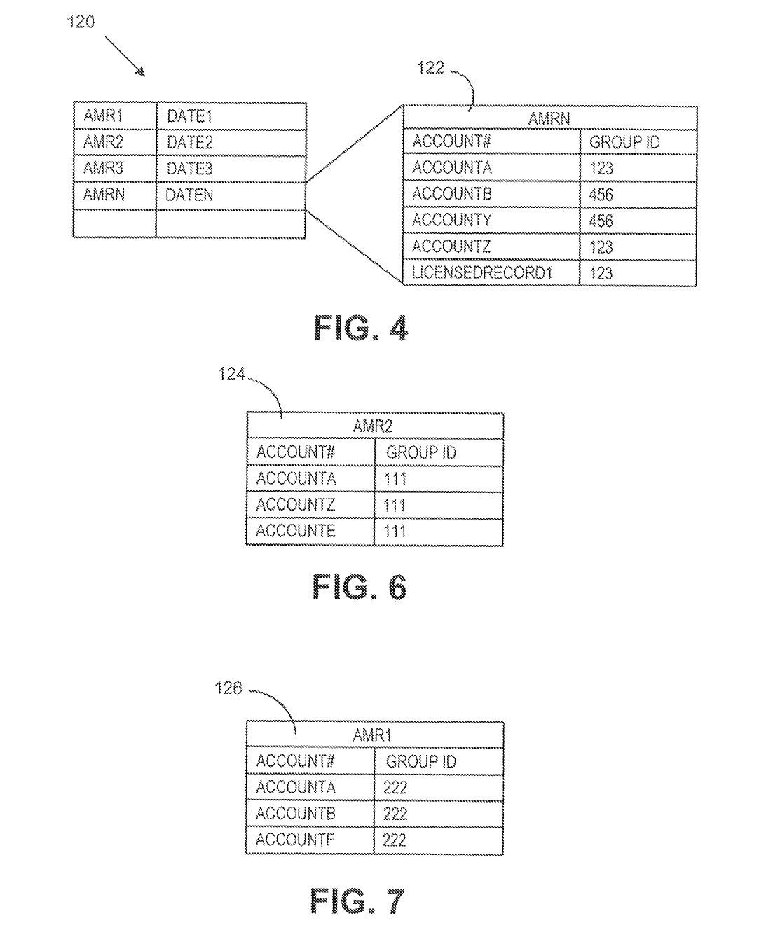

Referring now to FIG. 2, there is illustrated in flow diagram form a post-matching process for matching closed account records (inactive accounts) to active account records for use in analyzing multi-account customer locations across several time periods according to embodiments of the present invention. The process is performed by the system 10. In step 50, conventional matched address grouping records, obtained using the four part matching process as described above, are obtained and input to the system 10. Each address match result (AMR) provides a file for a specified time period. FIG. 4 illustrates an example of address match results 120 (AMR1 through AMRN) for different time periods (Date1 through the current or most recent date, DateN, respectively). The AMR from each time period includes a list of customer accounts and a group to which that customer account belongs based on matching with location, customer name, etc. For example, records of the time period N (AMRN 122) includes four accounts A, B, Y, Z, in which accounts A and B are in the same group (Group 123) and accounts Y and Z are in the same group (Group 456). It should be understood that as illustrated in FIG. 4, other information can also be included in these AMRs and assigned to specific groups. For example, third party licensed record LicenseRecord1 is included and assigned to Group 123. Thus, as described below, a group can consist of multiple entities, with the term entity as used herein meaning an account number, third party record, or any other information that can be included in a match record. In step 52, a new file is initialized that will include the entities from the records being processed along with new generated group identifiers. In step 54, an AMR is selected, preferably starting with the most current AMR, e.g., AMRN, as the most recent AMRs are generally assumed to be more accurate than older AMRs. In step 56, the records of the AMR are looped through to obtain the groups in that AMR (for example, looping through records of AMRN would obtain Groups 123 and 456). In step 58, a group is selected, and in step 60, the entities in the selected group are determined. Thus, for example, for Group 123, the entities are AccountA, Account Z, and LicensedRecord1.

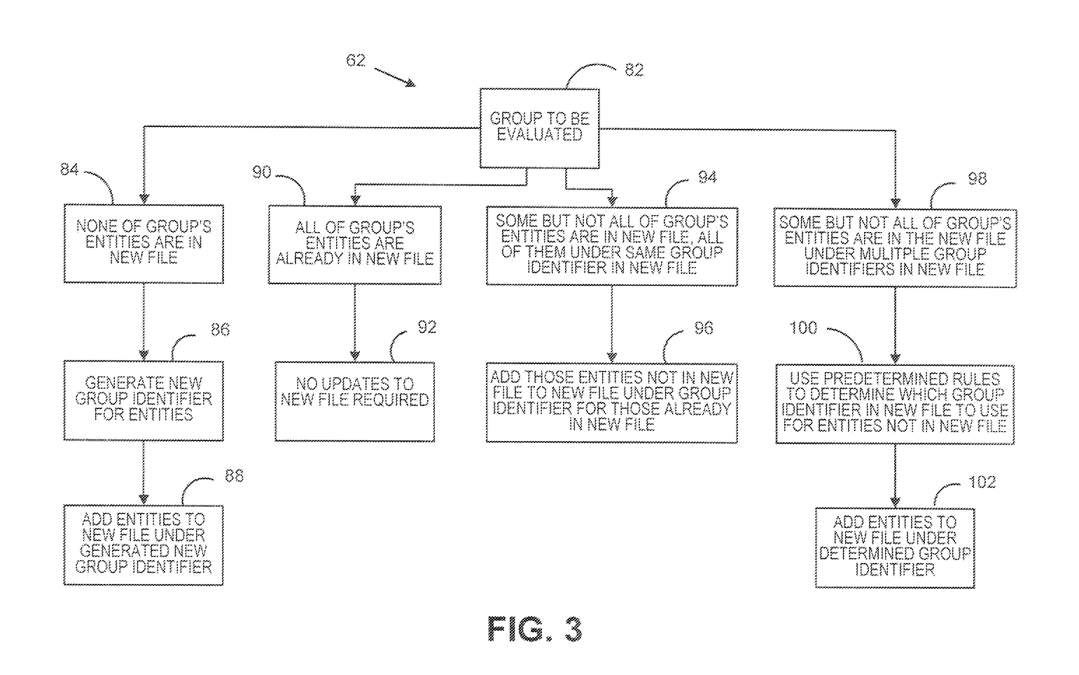

In step 62, the entities in the group are evaluated to determine where they should be placed in new groups contained in the new file (initialized in step 52) according to one of four possible outcomes as will be described further below with respect to FIG. 3. The process continues in step 64 by determining if there are more groups in the current AMR. If there are more groups in the current AMR e.g., Group 456, then processing returns to step 58 and repeats the processing of steps 60 and 62 for the next group. Once all of the groups in the current AMR have been looped through, then in step 66 it is determined if there are more AMRs to process. If there are, then the processing returns to step 54 for processing the next AMR, again preferably with the most recent time period of the remaining AMRs that have not already been processed. Each loop through the processing determines if the new file requires amending or not, with amendments being made either by adding additional entities to existing groups, or making and adding new groups as will be described below. Once all of the AMRs desired have been processed, then in step 66 the new file created during the processing is output. The new file will include not only current active accounts, but also inactive accounts that are matched to a current active account. Such output can be via a display device 14 of system 10, or a printed record made by printing device 22 of system 10.

Referring now to FIG. 3, there is illustrated the processing performed for evaluating entities in a group to determine where they should be placed in new groups contained in the new file (step 62 of FIG. 2). In step 82, the group to be evaluated is processed to determine in which one of four possible processing outcomes the group's entities should be processed. These outcomes include none of the group's entities are in the new file (step 84), all of the groups entities are already in the new file (step 90), some but not all of the group's entities are in the new file, and all of them are under the same group identifier in the new file (step 94), or some but not all of the group's entities are in the new file under multiple group identifiers in the new file (step 98). A further description of each of these, along with a simple example illustrating the processing, is provided below.

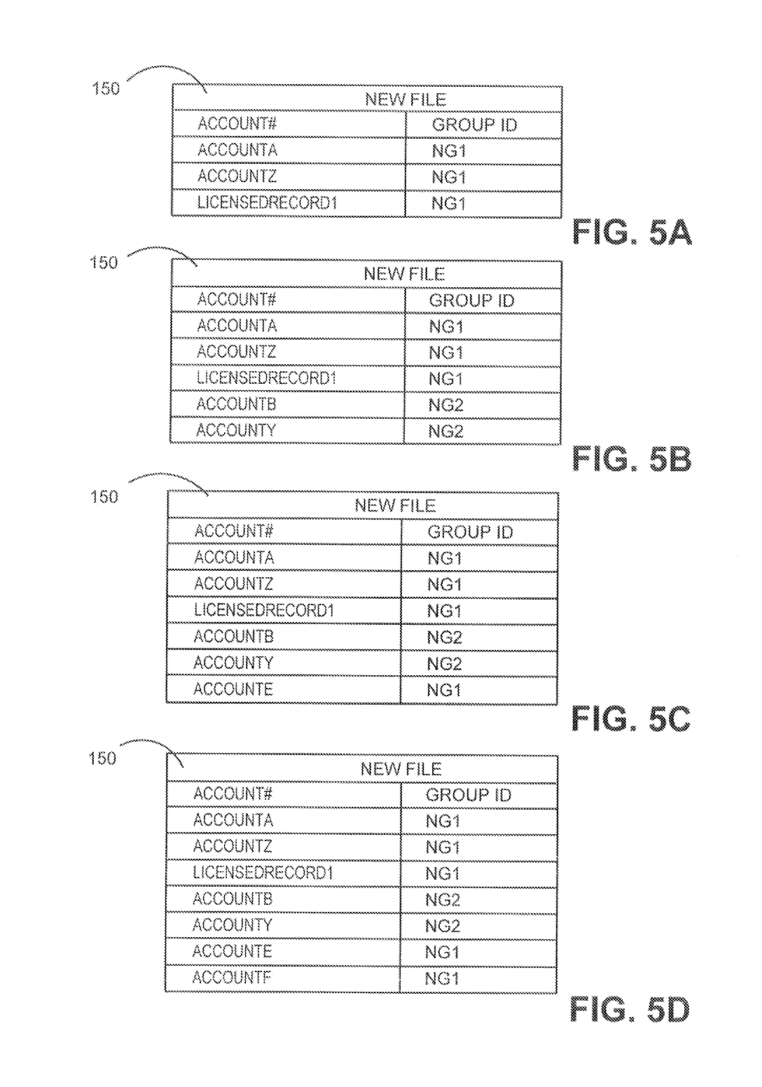

In the first outcome (step 84), none of the group's entities are included in the new file. For at least the first groups of the first AMR (that is, the most recent) being processed, and possibly several others, this will always be the case, as the initialized new file does not contain any entries yet. In step 86, a new group identifier for the entities is generated, and the entities are added to the new file under the generated new group identifier. Thus, as an example, assume that the AMRN 122 (FIG. 4) is the first AMR being processed. There are two groups in AMRN 122, i.e., Group123 and Group456. If the selected group (step 56 of FIG. 2) is Group123, the entities that belong to that group (step 58 of FIG. 2) are AccountA AccountZ, and LicensedRecord1. None of those entities are currently in the new file. Pursuant to step 86, a new identifier for a new group will be generated for each of these entities in this group, and the entities added to the new file under the generated new identifier (step 88). The resulting new file 150 will be as illustrated in FIG. 5A in which the new identifier is NewGroup1 (NG1). The processing in FIG. 2 will return in step 62 to select the next group, e.g., Group4S6. The entities that belong to this group are AccountB, and AccountY. Since none of the entities of this group are in the new file, a new identifier for this group is generated (step 86), and the entities added to the new filed under the generated new identifier. FIG. 5B illustrates the updated new file 150 after a new group (NG2) for entities AccountB and AccountY has been generated, and they have been added to the new file.

In the second outcome (step 90) all of the group's entities are already in the new file. Thus, for example, suppose a group being processed from AMR3 consisted of only entities AccountA and AccountZ. Since both entities AccountA and AccountZ are included in the new file (from previous processing of a different record/group as described above), there is no further action that needs to be performed for such a group and no updates are required to be made to the new file. The processing can then continue in step 64 of FIG. 2 to determine if there are more groups in the current AMR.

In the third outcome (step 94), some but not all of the group's entities are in the new file, and all of them are under the same group identifier in the new file. Thus, suppose, for example, AMR2 124 included a group (Group111) that included entities AccountA, AccountZ and AccountE as illustrated in FIG. 6. This means that at some previous date Date2 (the date of AMR2), there was some entity AccountE that was matched with AccountA and AccountZ. At some point subsequent to Date2, AccountE was closed, and therefore no longer appears in any subsequent AMRs, e.g., AMR3 or AMRN. Therefore, it is necessary to determine where AccountE belongs in the new file. Two of the entities (AccountA and AccountZ) in this group (Group111) are already included in the new file under identifier NG1, but AccountE is not included in the new file. In step 96, those entities that are not in the new file, e.g., AccountE, are added to the new file under the same group identifier as the entities from its group that are included in the new file. Thus, AccountE will be added to the new file under group NG1 (same as AccountA and AccountZ). FIG. 5C illustrates the updated new file 150 after entity AccountE has been added pursuant to step 96.

In the fourth outcome (step 98), some but not all of the group's entities are in the new file under multiple different group identifiers in the new file. Thus, suppose, for, example, that AMR1 126 included a group (Group222) that included entities AccountA, AccountB and AccountF as illustrated in FIG. 7. This means that at some previous date Date1 (the date of matching for AMR1), there was some entity AccountF that was matched with AccountA and AccountB, and AccountA and AccountB were matched under the same group. At some point subsequent to Date1, AccountF was closed, and therefore no longer appears in any subsequent AMRs, e.g., AMR2, AMR3 or AMRN, and AccountA and AccountB were split such that they are no longer in the same group, since AccountA and AccountB were matched with different groups at date N during the AMRN matching. This could have been caused, for example, by a location that included AccountA and AccountB splitting into different locations such that AccountA and AccountB are now separately located. Thus, for Group222, some of the entities (AccountA, AccountB) but not all (AccountF) are already in the new file, and those included are in different groups in the new file (AccountA is in Group NG1, while AccountB is in Group NG2). In step 100, predetermined rules are used to determine which group in the new file that AccountF should be added to, i.e., Group NG1 with AccountA or Group NG2 with AccountB. The predetermined rules can be stored in the memory device 16 of system 10, or some other database accessible by system 10. The rules can be determined based on analyst requirements and several factors, and therefore the results can be different depending on the desired outcome. Such rules can include, for example, the following: Place the entity with a currently active entity the other entities already in new file are not active. Place the entity with the entity having the largest revenue. Place the entity with the entity that is most recently established. Place the entity with the entity having the largest number of employees. This list is exemplary only, and other rules as desired can be utilized. As can be seen, the rules can depend on what data is currently available to the system 10 to make a decision as to where an entity in this situation, e.g., AccountF, should be grouped in the new file. Thus, suppose, for example, the predetermined rule is to place the entity with the entity having the largest revenue, and AccountA's revenue is larger than AccountB's revenue. In this situation, AccountF will be added to the new file in step 102 under the same group as AccountA, i.e., Group NG1. FIG. 5D illustrates the updated new file after entity AccountF has been added pursuant to steps 100-102.

The processing of entities in each group will continue as detailed above in FIG. 3 while looping through all of the groups in each of the AMRs being processed as detailed in FIG. 2. Each time the new file is updated to include entities from the groups being processed that are not already included in the new file with the best possible matching of any inactive entities to active entities. This matching allows a complete retrospective look at a multi-account customer location across several time periods. Since records from previous time periods are processed, inactive entities that may no longer appear in the most recent records are still included in the matching process, and are matched with current active entities in the best possible manner. Thus, for an analyst to perform a complete look at a customer location, the resulting new file will provide all of the entities that currently are or at one time during the period being reviewed associated with each other based on the group in the new file. Thus, for example, all entities under group NG1 in the new file are linked together, while all entities under group NG2 in the new file are linked together.

While preferred embodiments of the invention have been described and illustrated above, it should be understood that they are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for a processing device to generate a file that matches inactive accounts to active accounts included in address matching result output files from different time periods, each address matching result including at least one group containing at least one entity, the method comprising:
initializing, by the processing device, a new file to contain the matched inactive and active accounts;
evaluating, by the processing device, each group from each address matching result output file to place entities in each respective group into a new group in the new file by:
generating a new group identifier and adding the entities to the new file under the new identifier if none of the group's entities are already in the new file;
making no changes to the new file if all of the group's entities are already in the new file;
adding those entities not in the new file to the new file under a group identifier for those entities from the group that are already in the new file if some but not all of the groups entities are already in the new file and all of the entities already in the new file are under the same group identifier;
adding those entities not in the new file to the new file under a group identifier already in the new file using predetermined rules to select the group identifier if some but not all of the group's entities are already in the new file under multiple different group identifiers; and
outputting, by the processing device, the new file.

2. The method of claim 1, wherein the predetermined rules are based on at least one of whether or not the entities already in the new file are currently active, revenue of each entity already in the new file, date entities that are already in the new file were established, and number of employees of entities already in the new file.

3. A system for generating a file that matches inactive accounts to active accounts included in address matching result output files from different time periods, each address matching result including at least one group containing at least one entity, the system comprising:
a processing device; and
a memory device coupled to the processing device, the memory device storing instructions that when executed by the processing device, cause the processing device to:
initialize a new file to contain the matched inactive and active accounts;
evaluate each group from each address matching result output file to place entities in each respective group into a new group in the new file by:
generating a new group identifier and adding the entities to the new file under the new group identifier if none of the group's entities are already in the new file;
making no changes to the new file if all of the group's entities are already in the new file;
adding those entities not in the new file to the new file under a group identifier for those entities from the group that are already in the new file if some but not all of the groups entities are already in the new file and all of the entities already in the new file are under the same group identifier;
adding those entities not in the new file to the new file under a group identifier already in the new file using predetermined rules to select the group identifier if some but not all of the group's entities are already in the new file under multiple different group identifiers; and
output the new file.

4. The system of claim 3, wherein the predetermined rules are based on at least one of whether or not the entities already in the new file are currently active, revenue of each entity already in the new file, date entities that are already in the new file were established, and number of employees of entities already in the new file.
